(19) United States
(12) Patent Application Publication
(10) Pub. No.: US 2009/0119929 A1
(43) Pub. Date: May 14, 2009

(54) TREE TIMMING APPARATUS

(76) Inventors: Gary J. Monnig, Fullerton, CA (US); Jules P. Paquet, Fullerton, CA (US); Marc J. Paquet, Yorba Linda, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/936,956

(22) Filed: Nov. 8, 2007

(51) Int. Cl. A01G 3/025; A01G 3/08

(52) U.S. Cl. 30/249; 30/231

(57) ABSTRACT

The tree trimming apparatus includes a cutting head assembly adapted to be mounted to the end of a pole by a mounting bracket. A main lever arm is pivotally mounted at a first end to a support arm of a hook of the cutting head assembly, and a pulley receiving a rope for manual operation of the cutting or shearing blade is connected to the main lever arm. First and second parallel spaced apart link members are pivotally connected at their upper end portions to first and second sides of the blade lever arm, and are pivotally connected at their lower end portions to the first and second sides of the main lever arm, medially and near an end of the main lever arm. A coil return spring is connected between the lever arm of the cutting blade and a point on the main lever arm medially of the link members.

### BACKGROUND OF THE INVENTION

The present invention relates generally to tree trimming devices, and more particularly relates to a tree trimming apparatus with increased mechanical advantage for manual operation.

A conventional tree trimming and pruning apparatus includes an elongated pole or handle and a manually operated cutting head assembly mounted to an end of the pole. The cutting head assembly typically includes a hook and a blade cooperatively mounted adjacent to the hook for a shearing or scissoring action when the blade is actuated. A lever arm of the blade is conventionally directly connected to a rope or handle, and a return spring may be connected to the blade for returning the blade to a ready position after a cutting action has been accomplished. Increasing the mechanical advantage of such tree trimming and pruning devices can result in twisting or jamming of the cutting blade particularly when strong force is applied to move the cutting blade, and can result in loosening of the cutting blade from its mount and an increasing tendency of the cutting blade to twist or jam when strong force is applied to the cutting mechanism. It would therefore be desirable to provide a tree trimming and pruning device with increased mechanical advantage for operation of the apparatus, as well as an improved linkage of the cutting assembly to provide for uniform non-twisting operating forces on the cutting blade during operation. The present invention meets these and other needs.

### SUMMARY OF THE INVENTION

Briefly and in general terms, the present invention provides for a tree trimming apparatus that includes a cutting head assembly with a hook member and a cutting or shearing blade, adapted to be mounted to the end of a pole by a mounting bracket. A main lever arm is pivotally mounted at a first end to a support arm of the hook, and a pulley receiving a rope for manual operation of the cutting or shearing blade is connected to the main lever arm for increased mechanical advantage in operation of the cutting or shearing blade. First and second parallel spaced apart link members are pivotally connected at their upper end portions to first and second sides of the blade lever arm, and are pivotally connected at their lower end portions to the first and second sides of the main lever arm, medially and near an end of the main lever arm, to provide further increased mechanical advantage by compound lever action on the lever arm of the cutting blade. A coil return spring is connected between the lever arm of the cutting blade and a point on the main lever arm medially of the link members. The placement of the parallel spaced apart link members on either side of the cutting blade and on either side of the main lever arm provides for a uniform, non-twisting force on the cutting blade during actuation of the cutting assembly.

These and other features and advantages of the present invention will become more apparent from the following detailed description of the preferred embodiments in conjunction with the accompanying drawings, which illustrate, by way of example, the operation of the invention.

### BRIEF DESCRIPTION OF THE DRAWINGS

FIG. 1 is a perspective view of a tree trimming apparatus according to the present invention.

FIG. 2 is a side elevational view of a first variation of the tree trimming apparatus of the present invention, showing the main lever arm in an upward, ready position.

FIG. 3 is a side elevational view of the tree trimming apparatus of FIG. 2, showing the main lever arm in a downward, actuated position.

FIG. 4 is a side elevational view of a second variation of the tree trimming apparatus of the present invention, showing the main lever arm in an upward, ready position.

FIG. 5 is a side elevational view of the tree trimming apparatus of FIG. 4, showing the main lever arm in a downward, actuated position.

### DETAILED DESCRIPTION OF THE PREFERRED EMBODIMENTS

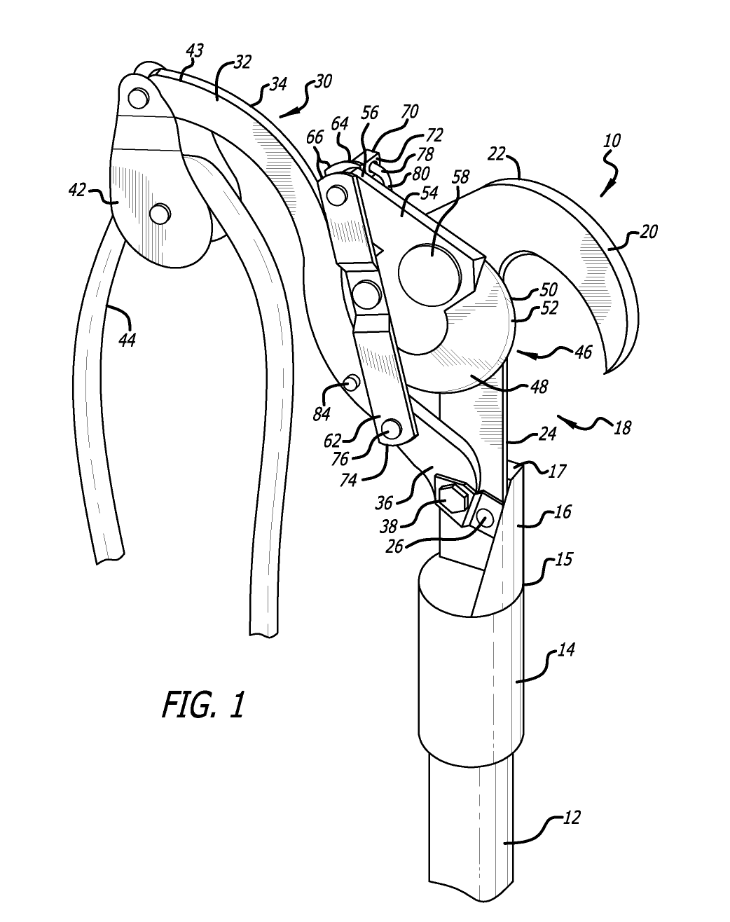

As is illustrated in FIG. 1, the present invention provides for a tree trimming apparatus 10 adapted to be mounted to an end of a pole or pole assembly 12, only a portion of which is shown, by a mounting bracket 14 adapted to fit over an end of the pole assembly, and optionally including a clamp or one or more fasteners (not shown) for connecting the mounting bracket to the pole. The mounting bracket is connected at one end 15 of the mounting bracket to the pole, and a flange or support post 16 extends from the other end 17 of the mounting bracket and is connected to the cutting head assembly 18.

The cutting head assembly includes a hook 20 having a head end 22 and a support arm 24 mounted by one or more fasteners 26, such as rivets, bolts or screws, to the flange or support post of the mounting bracket. As will be further explained below, a main lever arm 30 having planar sides 32, 34, is also pivotally mounted at a first end 36 to the support arm of the hook as well as to the flange or support post of the mounting bracket by a pivot pin 38 secured to the hook support arm and the flange or support post of the mounting bracket, such as by a nut (not shown). A pulley 42 is pivotally connected to the opposing second end 43 of the main lever arm. The pulley receives a rope 44, typically having one end (not shown) attached to a portion of the pole, or another pulley mechanism attached to the pole, and having a handle attached to the opposing end (not shown) of the rope for manually operating a cutting or shearing blade 46. One or more additional pulleys (not shown) may optionally be utilized in combination with the pulley 42, mounted on the main lever arm, for increasing mechanical advantage of the cutting blade.

The cutting or shearing blade has first and second planar sides 48, 50, a convex cutting edge portion 52, a main body portion 54, and a lever arm 56. The main body portion of the cutting or shearing blade is pivotally mounted to the head end portion 22 of the hook by a pivot pin 58, secured to the head end portion of the hook, such as by a nut (not shown). Advantageously, first and second parallel, spaced apart link members 62 and 64 are pivotally mounted at their first or upper end portions 66 on either side of the lever arm of the blade by a pivot pin 68 extending through the lever arm and having an extension portion 70 with an aperture 72 therethrough, as is explained further below. The first and second parallel link members are pivotally mounted at their second or lower end portions 74 to either side of the main lever arm medially and near the first end of the main lever arm by a pivot pin 76.

A coil return spring 78 is connected at a first end 80 to the pivot pin 68 through the aperture in the extension portion of the pivot pin. The opposing end (not shown) of the coil spring is connected by a support pin 84 to the main lever arm medially of the pivot pin 76 near the first end of the main lever arm.

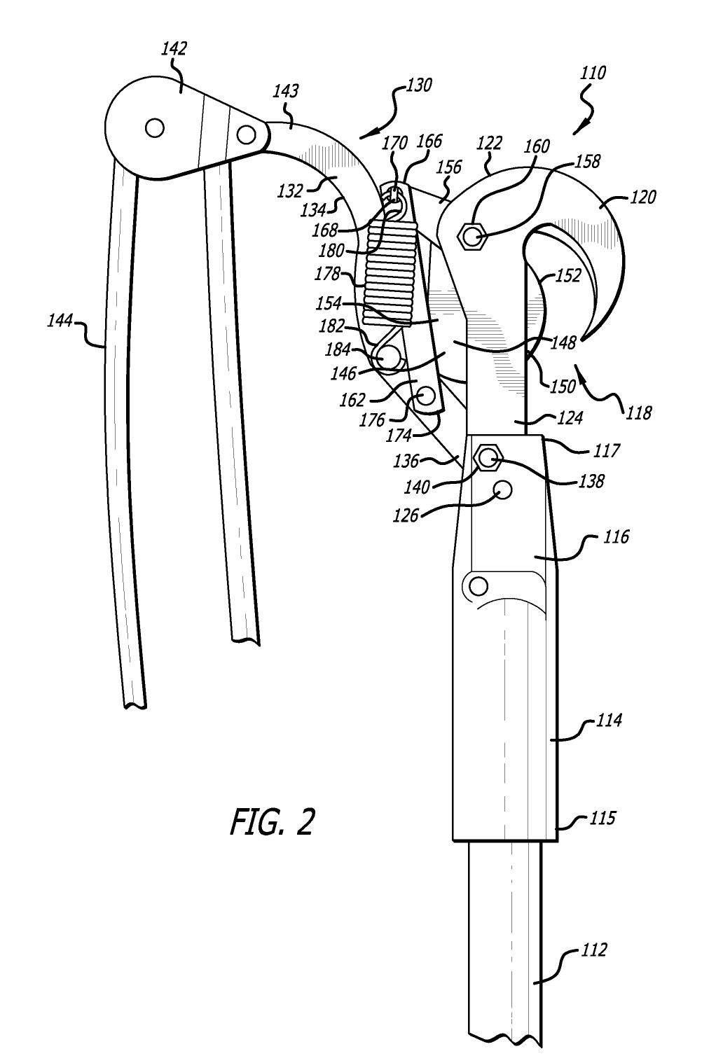

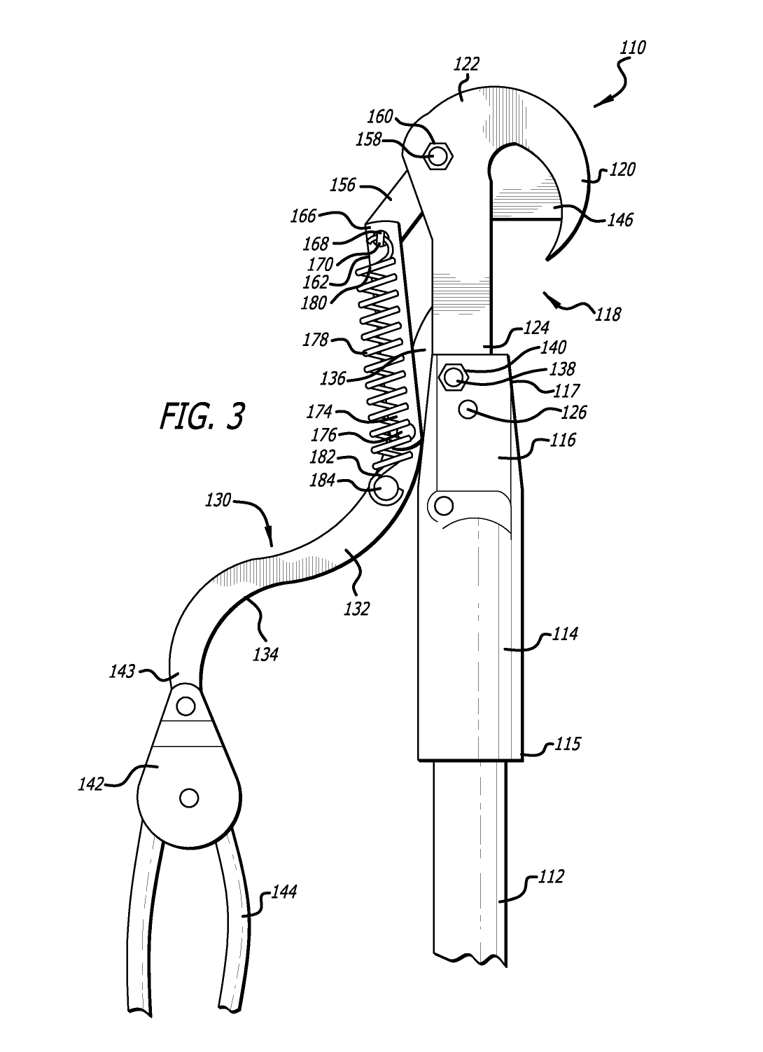

As is illustrated in FIGS. 2 and 3, in a first variation, the tree trimming apparatus 110 is adapted to be mounted to an end of a pole or pole assembly 112, only a portion of which is shown, by a mounting bracket 114 adapted to fit over an end of the pole assembly. The mounting bracket is connected at one end 115 of the mounting bracket to the pole, and a flange or support post 116 extends from the other end 117 of the mounting bracket and is connected to the cutting head assembly 118.

The cutting head assembly includes a hook 120 having a head end 122 and a support arm 124 mounted by one or more fasteners 126, such as rivets, bolts or screws, to the flange or support post of the mounting bracket. A main lever arm 130 having planar sides 132, 134, is pivotally mounted at a first end 136 to the support arm of the hook and to the flange or support post of the mounting bracket by a pivot pin 138 secured to the hook support arm and the flange or support post of the mounting bracket, such as by a nut 140. A pulley 142 is pivotally connected to the opposing second end 143 of the main lever arm. The pulley receives a rope 144, typically having one end (not shown) attached to a portion of the pole, or another pulley mechanism attached to the pole, and having a handle attached to the opposing end (not shown) of the rope for manually operating a cutting or shearing blade 146. One or more additional pulleys (not shown) may optionally be utilized in combination with the pulley 142, mounted on the main lever arm, for increasing mechanical advantage of the cutting blade.

The cutting or shearing blade has first and second planar sides 148, 150, a convex cutting edge portion 152, a main body portion 154, and a lever arm 156. The main body portion of the cutting or shearing blade is pivotally mounted to the head end portion 122 of the hook by a pivot pin 158, secured to the head end portion of the hook, such as by a nut 160. First and second parallel, spaced apart link members 162 (only one of which is shown) are pivotally mounted at their first or upper end portions 166 on either side of the lever arm of the blade by a pivot pin 168 extending through the lever arm and having an extension portion 170 with an aperture (not shown) therethrough, as is explained further below. The first and second parallel link members are pivotally mounted at their second or lower end portions 174 to either side of the main lever arm medially and near the first end of the main lever arm by a pivot pin 176.

A coil return spring 178 is connected at a first end 180 to the pivot pin 168 through the aperture in the extension portion of the pivot pin. The opposing second end 182 of the coil spring is connected by a support pin 184 to the main lever arm medially of the pivot pin 176 near the first end of the main lever arm.

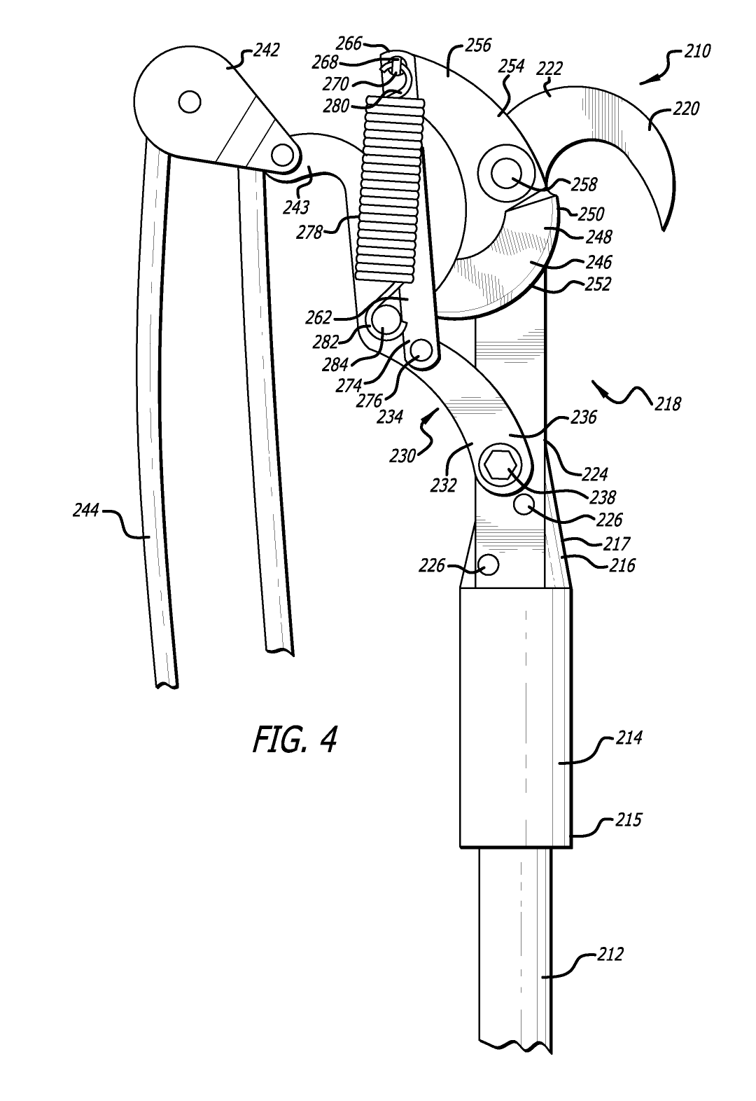

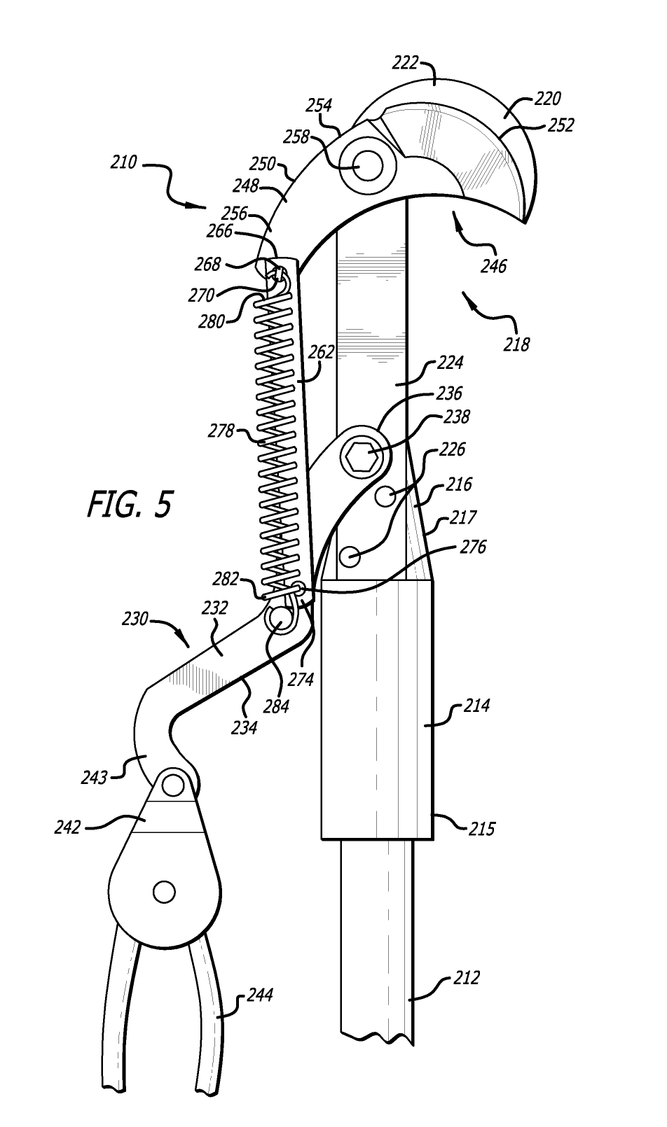

As is illustrated in FIGS. 4 and 5, in a second variation, the tree trimming apparatus 210 is adapted to be mounted to an end of a pole or pole assembly 212, only a portion of which is shown, by a mounting bracket 214 adapted to fit over the end of the pole assembly. The mounting bracket is connected at one end 215 of the mounting bracket to the pole, and a flange or support post 216 extends from the other end 217 of the mounting bracket and is connected to the cutting head assembly 218.

The cutting head assembly includes a hook 220 having a head end 222 and a support arm 224 mounted by one or more fasteners 226, such as rivets, bolts or screws, to the flange or support post of the mounting bracket. The main lever arm 230 having planar sides 232, 234 is also pivotally mounted at a first end 236 to the support arm of the hook and to the flange or support post of the mounting bracket by a pivot pin 238 secured to the hook support arm and the flange or support post of the mounting bracket, such as by a nut 240. A pulley 242 is pivotally connected to the opposing second end 243 of the main lever arm. The pulley receives a rope 244, typically having one end (not shown) attached to a portion of the pole, or another pulley mechanism attached to the pole, and having a handle attached to the opposing end (not shown) of the rope for manually operating a cutting or shearing blade 246. One or more additional pulleys (not shown) may optionally be utilized in combination with the pulley 242, mounted on the main lever arm, for increasing mechanical advantage of the cutting blade.

The cutting or shearing blade has first and second planar sides 248, 250, a convex cutting edge portion 252, a main body portion 254, and a lever arm 256. The main body portion of the cutting or shearing blade is pivotally mounted to the head end portion 222 of the hook by a pivot pin 258, secured to the head end portion of the hook, such as by a nut 260. First and second parallel, spaced apart link members 262 (only one of which is shown) are pivotally mounted at their first or upper end portions 266 on either side of the lever arm of the blade by a pivot pin 268 extending through the lever arm and having an extension portion 270 with an aperture (not shown) therethrough, as is explained further below. The first and second parallel link members are pivotally mounted at their second or lower end portions 274 to either side of the main lever arm medially and near the first end of the main lever arm by a pivot pin 276.

A coil return spring 278 is connected at a first end 280 to the pivot pin 268 through the aperture in the extension portion of the pivot pin. The opposing second end 282 of the coil spring is connected by a support pin 284 to the main lever arm medially of the pivot pin 276 near the first end of the main lever arm.

The tree trimming apparatus can be operated manually for a cutting stroke by pulling on the rope downwardly toward the pole, which pulls the second end of the main lever arm downward, causing the link members to rotate the cutting or shearing blade toward and shearing against the hook member, in a scissoring action. The cutting stroke lengthens the coil spring, and a return stroke of the tree trimming apparatus is actuated by the coil spring to return the main lever arm upward to a ready position.

It will be apparent from the foregoing that while particular forms of the invention have been illustrated and described, various modifications can be made without departing from the spirit and scope of the invention. Accordingly, it is not intended that the invention be limited, except as by the appended claims.

1. A tree trimming apparatus adapted to be mounted to an end of a pole for manual operation of the tree trimming apparatus, comprising:
a cutting head assembly including a mounting bracket adapted to be secured to the pole;
a hook member having a head end and a support arm mounted to the mounting bracket;
a cutting blade having first and second planar sides, a cutting edge portion, a main body portion pivotally connected to the head end portion of the hook, and a lever arm opposing the cutting edge portion;
a main lever arm having a first end and an opposing second end, first and second planar sides, said main lever arm being pivotally mounted at the first end to the hook support arm;
a pulley pivotally connected to the opposing end of the main lever arm, said pulley receiving a rope for manually operating the cutting blade;
first and second parallel, spaced apart link members, said link members having first end portions and second end portions, said link members being pivotally mounted at their first end portions to the first and second sides of the cutting blade lever arm, and said link members being pivotally mounted at their second end portions to the first and second sides of the main lever arm medially and adjacent the first end of the main lever arm; and
a coil spring having a first end and a second end, said coil spring being connected at the first end to the lever arm of the cutting blade, and the second end of the coil spring being connected to the main lever arm medially of the link members adjacent the first end of the main lever arm.

2. The tree trimming apparatus of claim 1, wherein said mounting bracket of the cutting head assembly comprises a support post, and said support arm of said hook member is mounted to the support post of the mounting bracket.

3. The tree trimming apparatus of claim 2, wherein said main lever arm is pivotally mounted at the first end to said hook member support arm and the support post of the mounting bracket.

4. The tree trimming apparatus of claim 1, wherein said first and second parallel, spaced apart link members are pivotally mounted at their first end portions to the first and second sides of the cutting blade lever arm.

5. The tree trimming apparatus of claim 4, wherein said pivot pin extending through the cutting blade lever arm comprises an extension portion with an aperture therethrough, and said coil spring is connected at the first end of the coil spring to the pivot pin extending through the cutting blade lever arm through the aperture in the extension portion of the pivot pin extending through the cutting blade lever arm.

6. The tree trimming apparatus of claim 1, wherein said first and second parallel, spaced apart link members are pivotally mounted at their second end portions to the first and second sides of the main lever arm by a pivot pin medially and adjacent to the first end of the main lever arm, and the second end of the coil spring is connected to the main lever arm medially of the link members by a support pin to the main lever arm medially of the pivot pin medially and adjacent to the first end of the main lever arm.

7. The tree trimming apparatus of claim 3, wherein said main lever arm is pivotally mounted at the first end of the main lever arm and to the hook support arm and the support post of the mounting bracket by a pivot pin connected to the hook support arm and the support post of the mounting bracket.
